(19) United States
(12) Patent Application Publication
(10) Pub. No.: US 2026/0147341 A1
(43) Pub. Date: May 28, 2026

(54) REMOTE SUPPORT SYSTEM

(71) Applicant: TOYOTA JIDOSHA KABUSHIKI KAISHA, Toyota-shi (JP)

(72) Inventor: Hirofumi MOMOSE, Numazu-shi (JP)

(73) Assignee: TOYOTA JIDOSHA KABUSHIKI KAISHA, Toyota-shi (JP)

(21) Appl. No.: 19/379,809

(22) Filed: Nov. 5, 2025

(30) Foreign Application Priority Data
Nov. 22, 2024 (JP) 2024-204148

(51) Int. Cl. G05D 1/224; G05D 109/10; G05D 111/10; G05D 111/30; G06V 10/10; G06V 20/56

(52) U.S. Cl. CPC G05D 1/2247; G06V 10/16; G06V 20/56; G05D 2109/10; G05D 2111/10; G05D 2111/32

(57) ABSTRACT

The remote support system includes a vehicle and a remote support device. The vehicle includes a plurality of cameras. The remote support device is a device that communicates with the vehicle and performs remote support for the vehicle. At least one of the vehicle and the remote support device includes an image synthesizing device that synthesizes a plurality of camera images captured by a plurality of cameras in accordance with a predetermined image synthesis rule. The remote support device includes a display configured to display the synthesized image synthesized by the image synthesizing device, and an adjustment device configured to adjust the image synthesis rule in response to an operation of a user of the remote support device.

### CROSS-REFERENCE TO RELATED APPLICATION

This application claims priority to Japanese Patent Application No. 2024-204148 filed on Nov. 22, 2024. The disclosure of the above-identified application, including the specification, drawings, and claims, is incorporated by reference herein in its entirety.

### BACKGROUND

### 1. Technical Field

The present disclosure relates to a technique for remotely supporting a vehicle.

### 2. Description of Related Art

Japanese Unexamined Patent Application Publication No. 5-173630 (JP 5-173630 A) discloses a visual device for an unmanned vehicle. The visual device is provided in a remote control unit configured to remotely control the unmanned vehicle, and performs signal processing of scaling down an image signal from a narrow-range imaging device and inserting the scaled-down image signal at a position that is predetermined in an image signal from a wide-range imaging device.

### SUMMARY

The visual device described in JP 5-173630 A does not include a configuration of adjusting an image displayed on a display unit by an operator who remotely controls the unmanned vehicle. Therefore, a technique described in JP 5-173630 A has room for improvement in reducing a burden related to the remote control on the operator.

The present disclosure was made in view of the above problem, and an object of the present disclosure is to provide a remote support system that contributes to reducing a burden on a user who uses a remote support device for remote support (for example, remote driving, remote assistance, and remote monitoring) for a vehicle.

A remote support system according to the present disclosure includes a vehicle and a remote support device.

The vehicle includes a plurality of cameras.

The remote support device is a device of performing communication with the vehicle and performing remote support for the vehicle.

At least one of the vehicle and the remote support device includes an image synthesizing device configured to synthesize a plurality of camera images captured by the cameras in accordance with an image synthesis rule that is predetermined.

The remote support device includes a display configured to display a synthesized image synthesized by the image synthesizing device, and an adjustment device configured to adjust the image synthesis rule in accordance with an operation of a user of the remote support device.

According to the present disclosure, it is possible to provide the user who performs the remote support for the vehicle with a function of adjusting the image synthesis rule regarding the synthesized image displayed on the display of the remote support device. This contributes to reducing a burden on the user who uses the remote support device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration example of a remote support system according to Embodiment 1;

FIG. 2 is a conceptual diagram showing an example of image synthesis by the image synthesizer shown in FIG. 1;

FIG. 3 is a schematic diagram showing a configuration example of a remote support system according to a first modification of Embodiment 1;

FIG. 4 is a schematic view showing a configuration example of a remote support system according to a second modification of Embodiment 1;

FIG. 5 is a schematic diagram showing a configuration example of a remote support system according to a third modification of Embodiment 1;

FIG. 6 is a schematic diagram showing a configuration example of a remote support system according to Embodiment 2;

FIG. 7 is a schematic diagram showing a configuration example of a remote support system according to a first modification of Embodiment 2;

FIG. 8 is a schematic diagram showing a configuration example of a remote support system according to a second modification of Embodiment 2;

FIG. 9 is a schematic view showing a configuration example of a remote support system according to Embodiment 3; and

FIG. 10 is a conceptual diagram showing an example of image synthesis by the first image synthesizer and the second image synthesizer shown in FIG. 9.

### DETAILED DESCRIPTION OF EMBODIMENTS

Embodiments of the present disclosure will be described with reference to the accompanying drawings. In addition, the same reference numerals are given to the same elements in each drawing, and the description thereof will be omitted or simplified.

### Embodiment 1

### Configuration of Remote Support System

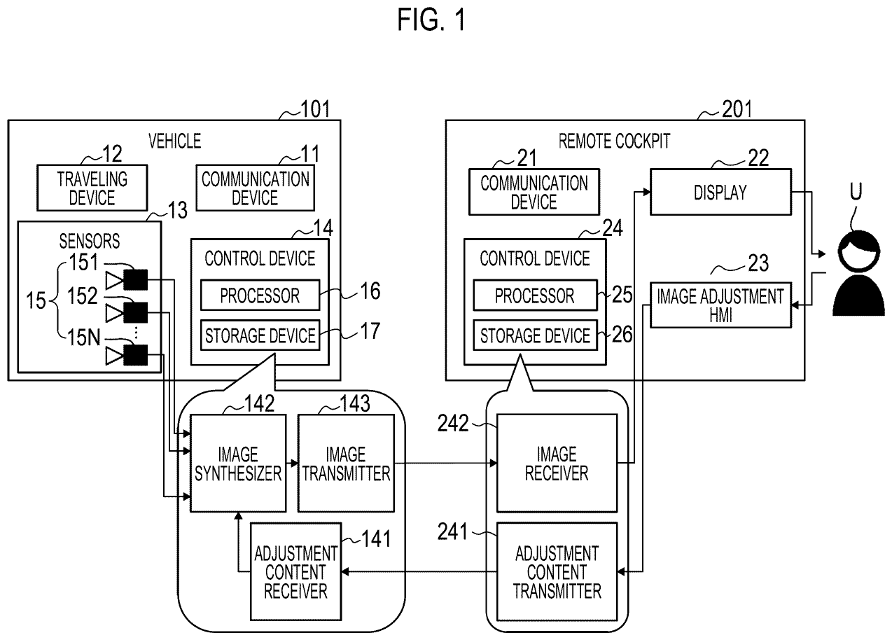

FIG. 1 is a schematic diagram showing a configuration example of a remote support system 1 according to Embodiment 1. The remote support system 1 is a system for remote support of the vehicle. The remote support is a concept including remote driving, remote assistance, and remote monitoring. As shown in FIG. 1, the remote support system 1 includes a vehicle 101 that is a remote support target and a remote cockpit 201. The vehicle 101 and the remote cockpit 201 can communicate with each other via a wireless communication network.

The vehicle 101 is configured to be remotely supported (for example, remote driving) by a user (remote supporter) 1 who uses the remote cockpit 201. As an example, the vehicle 101 is an autonomous driving vehicle. The vehicle 101 includes, for example, a communication device 11, a traveling device 12, sensors 13, and a control device 14. The communication device 11 performs wireless communication with the outside of the vehicle 101. For example, the communication device 11 performs wireless communication with the remote cockpit 201.

The traveling device 12 includes a steering device, a drive device, and a braking device. The steering device turns the wheels of the vehicle 101. The drive device is a power source that generates a driving force of the vehicle 101, and includes at least one of an electric motor and an internal combustion engine. The braking device generates a braking force.

The sensors 13 include, for example, a recognition sensor, a vehicle state sensor, and a position sensor. The recognition sensor recognizes (detects) a situation around the vehicle 101. The recognition sensor includes, for example, a plurality of cameras 15 (151 to 15N; N is an integer of two or more) that captures a plurality of peripheral situations of the vehicle 101. The vehicle state sensor detects a state of the vehicle 101 (for example, a yaw rate, a wheel speed, a vehicle speed, an acceleration, and a steering angle). The position sensor detects a position and an orientation of the vehicle 101.

The control device 14 controls traveling of the vehicle 101. The control device 14 provides the user U with the image V captured by the camera 15 in cooperation with the remote cockpit 201. The control device 14 includes one or more processors 16 (hereinafter, simply referred to as the processor 16) and one or more storage devices 17 (hereinafter, simply referred to as the storage device 17). The processor 16 executes various processes including processing related to the control of the vehicle 101. Examples of the processor 16 include a general-purpose processor, a specific-purpose processor, a central processing unit (CPU), a graphics processing unit (GPU), an application specific integrated circuit (ASIC), and a field-programmable gate array (FPGA). The storage device 17 stores various kinds of information needed for various kinds of processing. Examples of the storage device 17 include a volatile memory, a non-volatile memory, a hard disk drive (HDD), and a solid state drive (SSD). The processor 16 executes a computer program. The computer program is stored in the storage device 17. The computer program may be recorded on a computer-readable recording medium. The functions of the control device 14 are realized by the processor 16 and the storage device 17 in cooperation with each other to execute the computer program.

The remote cockpit 201 corresponds to an example of a “remote support terminal” included in a “remote support device” for the user U to perform the remote support of the vehicle 101 (cockpit type terminal). The remote cockpit 201 is operated by the user U for the remote support of the vehicle 101. The remote cockpit 201 includes a communication device 21, one or more displays 22 (hereinafter, simply referred to as a display 22), an image adjustment human-machine interface (HMI) 23, and a control device 24.

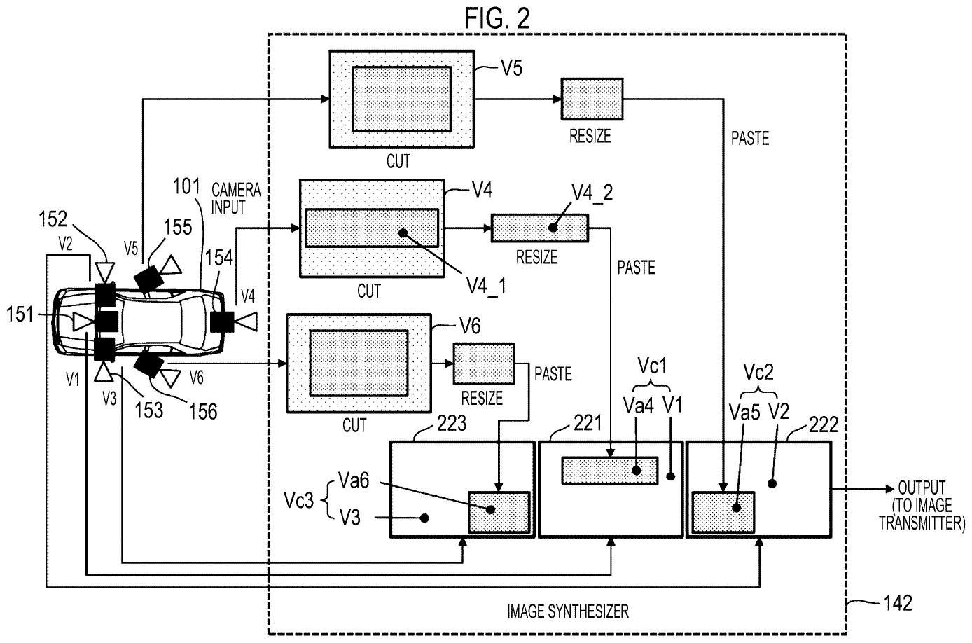

The communication device 21 communicates with the vehicle 101. The display 22 displays images V (V1 to VN; N is an integer of two or more) captured by a plurality of cameras 15 mounted on the vehicle 101 (for example, see FIG. 2). Although details will be described later, the image adjustment HMI 23 receives an input from the user U. The remote cockpit 201 may include an input device (for example, a steering wheel, an accelerator pedal, and a brake pedal) operated by the user U for the remote driving of the vehicle 101.

The control device 24 controls the remote cockpit 201. The control device 24 provides the user U with the image V via the display 22 in cooperation with the control device 14 of the vehicle 101. The control device 24 includes one or more processors 25 (hereinafter, simply referred to as processor 25) and one or more storage devices 26 (hereinafter, simply referred to as storage device 26). A configuration example of the processor 25 is the same as that of the processor 16. In addition, a configuration example of the storage device 26 is the same as that of the storage device 17. The processor 25 executes a computer program. The computer program is stored in the storage device 26. The computer program may be recorded on a computer-readable recording medium. The functions of the control device 24 are realized by the processor 25 and the storage device 26 cooperating with each other to execute the computer program.

### Display of Image V on Display

As described above, in the remote support system 1, the images V of the cameras 15 are displayed on the display 22 of the remote cockpit 201. The remote support system 1 includes an “image synthesizing device” that synthesizes a plurality of images V1 to VN (a plurality of camera images) captured by the cameras 15 according to a predetermined image synthesis rule R. In Embodiment 1, the control device 14 of the vehicle 101 includes an image synthesizing device. The display 22 displays the synthesized image Vc synthesized by the image synthesizing device. The remote cockpit 201 (remote support device) includes an “adjustment device” that adjusts the image synthesis rule R in response to the operation of the user U. In FIG. 1, the image adjustment HMI 23 corresponds to the adjustment device.

FIG. 1 represents a functional block related to the provision of the image V to the user U. As the function block, the control device 24 of the remote cockpit 201 includes an adjustment content transmitter 241 and an image receiver 242. On the other hand, the control device 14 of the vehicle 101 includes an adjustment content receiver 141, an image synthesizer 142, and an image transmitter 143. The function blocks are software-implemented when a computer program for providing the image V is executed by the processor 25 or 16. Hereinafter, the processing of each of the functional blocks in FIG. 1 will be described with reference to FIG. 2.

FIG. 2 is a conceptual diagram showing an example of image synthesis by the image synthesizer 142 shown in FIG. 1. In the example shown in FIG. 2, the vehicle 101 includes six cameras 15 (front camera 151, right front camera 152, left front camera 153, rear camera 154, right rear camera 155, and left rear camera 156).

The remote cockpit 201 includes, for example, three displays 22 (221, 222, 223). Specifically, the center display 221 displays the image V1 (front view image of the vehicle 101) from the front camera 151. The right display 222 is disposed on the right side of the center display 221 in the remote cockpit 201, and displays the image V2 (right front view image of the vehicle 101) from the right front camera 152. The left display 223 is disposed on the left side of the center display 221, and displays the image V3 (left front view image of the vehicle 101) from the left front camera 153. The images V1, V2, V3 are overview images.

In addition, the center display 221 displays the image V4 of the rear camera 154 (hereinafter, referred to as an adjusted image Va4) after the image adjustment described below is performed by the image synthesizer 142 in a superimposed and auxiliary manner. That is, the center display 221 displays the synthesized image Vc1 synthesized by the image synthesizer 142 from the image V1 and the adjustment image Va4. Similarly, the right display 222 displays the image V5 (hereinafter, referred to as an adjusted image Va5) of the right rear camera 155 after the image adjustment in a superimposed manner. That is, the right display 222 displays the synthesized image Vc2 obtained by synthesizing the adjustment image Va5 and the image V2. The left display 223 displays the image V6 of the left rear camera 156 after the image adjustment (hereinafter, referred to as the adjusted image Va6) in a superimposed manner. That is, the left display 223 displays the synthesized image Vc3 synthesized from the adjustment image Va6 and the image V3. In addition, the image V4 is a rear view image (image corresponding to a rearview mirror) of the vehicle 101. The images V5 and V6 are right rear view image and left rear view image (image corresponding to a door mirror) of the vehicle 101, respectively.

In the remote support system 1, the user U can operate the image adjustment HMI 23 to adjust the image synthesis rule R in image synthesis by the image synthesizer 142 (customization function). In the example shown in FIG. 2, the image synthesis rule R determines how the images V4, V5, V6 are displayed on the displays 221, 222, 223. The image synthesis rule R relates to, for example, at least one of the setting of the cutting, the resizing, and the pasting position of the image V.

In FIG. 1, the image adjustment HMI 23 receives the input of the image synthesis rule R from the user U who desires to adjust the image synthesis rule R. That is, the image synthesis rule R is adjusted by the signal from the image adjustment HMI 23 operated by the user U. The image adjustment HMI 23 outputs the content (image adjustment content) of the image synthesis rule R input by the user U to the adjustment content transmitter 241. The adjustment content transmitter 241 transmits the image adjustment content of the image acquired from the image adjustment HMI 23 to the vehicle 101.

The adjustment content receiver 141 receives the image adjustment content from the remote cockpit 201 and outputs the received image adjustment content to the image synthesizer 142. The image synthesizer 142 produces the synthesized image Vc from the images V of the respective cameras 15 in accordance with the image adjustment content acquired from the adjustment content receiver 141.

Specifically, in the example shown in FIG. 2, the image synthesizer 142 cuts a part of the image V4 of the rear camera 154 as the image V4_1 in accordance with the content of the cutting setting of the image V4 included in the image adjustment content. Next, the image synthesizer 142 resizes the cut image V4_1 in accordance with the content of the resize setting of the image V4 to acquire an image V4_2. Next, the image synthesizer 142 pastes the resized image V4_2 as the adjustment image Va4 onto the image V1 in a superimposed manner in accordance with the pasting position setting content of the image V4. As a result, the synthesized image Vc1 is produced. The production of the synthesized images Vc2 and Vc3 accompanied by the images V5 and V6, respectively, can also be performed in the same manner as shown in FIG. 2.

The image synthesizer 142 outputs the synthesized image Vc (for example, Vc1, Vc2, Vc3) produced as described above to the image transmitter 143. The image transmitter 143 transmits the acquired synthesized image Vc to the remote cockpit 201. The image receiver 242 receives the synthesized image Vc from the vehicle 101 and outputs the received synthesized image Vc to the display 22. As a result, for example, as shown in FIG. 2, the synthesized image Vc is displayed on the display 22.

As described above, with the remote support system 1 according to Embodiment 1, the customization function can be provided to the user U who performs the remote support of the vehicle 101. The customization function is a function of adjusting the image synthesis rule R regarding the synthesized image Vc displayed on the display 22 of the remote cockpit 201. As a result, it is possible to provide the synthesized image Vc that is easy to see for each user U. This contributes to reducing the burden on the user U who uses the remote cockpit 201 (remote support device) for the remote support.

### First Modification

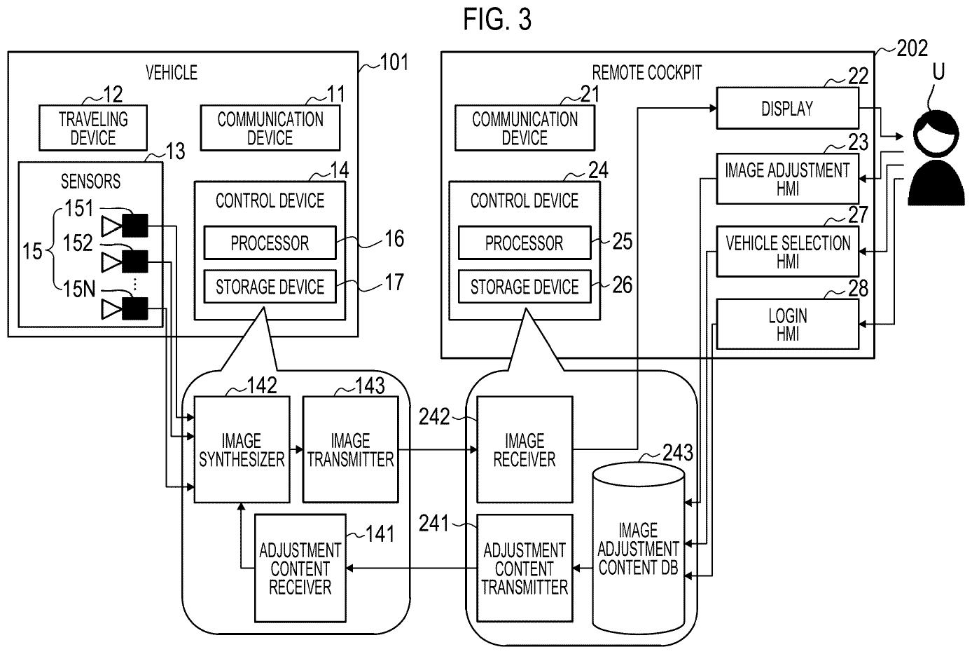

FIG. 3 is a schematic diagram showing a configuration example of the remote support system 2 according to a first modification of Embodiment 1. The remote support system 2 is different from the remote support system 1 shown in FIG. 1 in the configuration of the “remote support device”.

In comparison with the remote cockpit 201 (see FIG. 1), the remote cockpit 202 shown in FIG. 3 further includes a vehicle selection HMI 27 and a login HMI 28. The control device 24 of the remote cockpit 202 further includes an image adjustment content database (image adjustment content DB) 243. The image adjustment content DB 243 stores the content (image adjustment content) of the image synthesis rule R adjusted by the image adjustment HMI 23 (adjustment device) by the operation of the user U for each user U. The image adjustment content DB 243 is stored in the storage device 26. In addition, in the example of the image adjustment content DB 243 shown in FIG. 3, the image adjustment content is stored for each user U and for each vehicle 101 that is the target of the remote support.

In the remote support system 2, when the user U starts using the remote cockpit 202, the user U logs in to the remote cockpit 202 by operating the login HMI 28. For example, the user U operates the login HMI 28 to input his/her user ID and password. Next, the user U operates the vehicle selection HMI 27 to input the vehicle ID of the vehicle 101 for which the user U performs the remote support, that is, to select the vehicle 101 that is the target of the remote support of the user U. In the example shown in FIG. 3, the remote cockpit 202 includes three HMIs 23, 27, 28 individually, but two or three of the HMIs 23, 27, 28 may be integrated.

The remote cockpit 202 (processor 25) searches the image adjustment content DB using the user ID and the vehicle ID acquired through the HMIs 28, 27, and acquires the image adjustment content corresponding to the acquired user ID and vehicle ID. More specifically, the image adjustment content DB 243 stores the content of the setting of the image V associated with the camera ID of the cameras 15 of the vehicle 101 (for example, the cutting setting, the resize setting, and the paste position setting) as the image adjustment content. When the image adjustment content corresponding to the input user ID and the vehicle ID is not registered in the image adjustment content DB, a preset initial value is used as the image adjustment content.

In the example shown in FIG. 3, the adjustment content transmitter 241 transmits the adjustment content acquired from the image adjustment content DB 243 to the vehicle 101, as described above. The processing of the other functional blocks in FIG. 3 is the same as that of the example shown in FIG. 1.

In the remote cockpit 202 shown in FIG. 3, the user U can optionally operate the image adjustment HMI 23 to change the image adjustment content for the selected vehicle 101. The remote cockpit 202 updates the image adjustment content DB 243 with the content input by the user U through the image adjustment HMI 23. As a result, the vehicle 101 produces the synthesized image Vc in accordance with the updated image adjustment content, and the synthesized image Vc is displayed on the display 22 of the remote cockpit 202. The user U can repeatedly operate the image adjustment HMI 23 until the desired synthesized image Vc is obtained to adjust the display manner of the synthesized image Vc (image synthesis rule R).

As described above, the function (image adjustment content DB 243) of storing the image adjustment content for each user U is added to the remote cockpit 202 (remote support device) according to the first modification. As a result, the image adjustment content (that is, the image adjustment result) set by the user U can be saved and the image adjustment content can be reproduced at the time of the next remote support. Therefore, the remote support system 2 with higher practicality can be provided.

### Second Modification

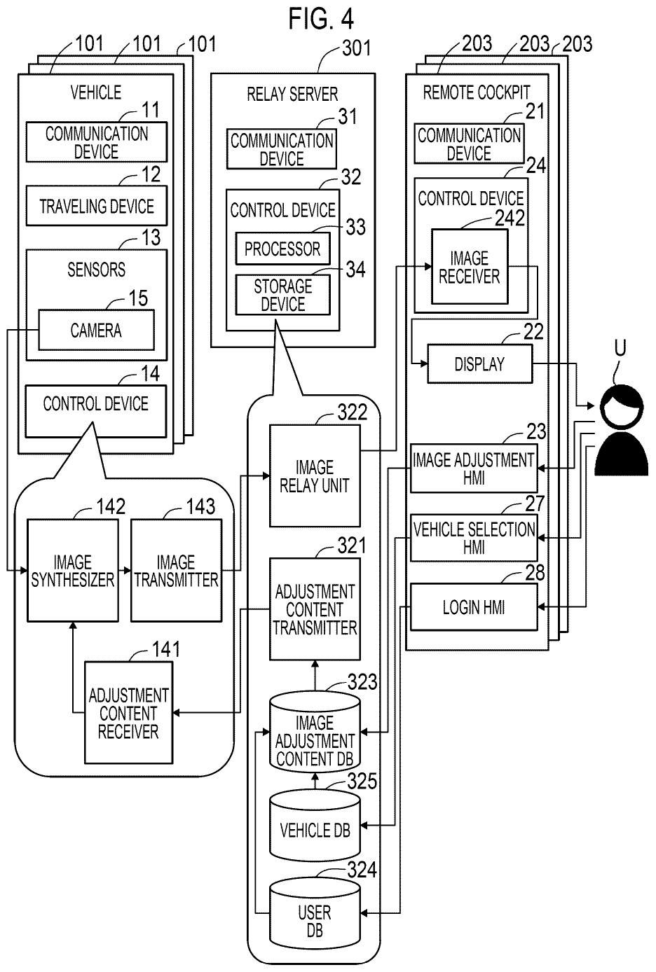

FIG. 4 is a schematic diagram showing a configuration example of the remote support system 3 according to a second modification of Embodiment 1. The remote support system 3 is different from the remote support system 2 shown in FIG. 3 in the configuration of the “remote support device”. Specifically, the remote support device in the remote support system 3 includes a remote cockpit 203 (remote support terminal) and a relay server 301.

In comparison with the remote cockpit 202 (see FIG. 3), the remote cockpit 203 includes solely the image receiver 242 as a functional block.

The relay server 301 relays the communication between the vehicle 101 and the remote cockpit 203. The relay server 301 includes a communication device 31 and a control device 32. The communication device 31 communicates with a plurality of vehicles 101 that configure the remote support system 3. The communication device 31 also communicates with a plurality of remote cockpits 203 that configure the remote support system 3. The control device 32 provides the user U with the image V in cooperation with the remote cockpit 203 and the vehicle 101. The control device 32 includes one or more processors 33 (hereinafter, simply referred to as processor 33) and one or more storage devices 34 (hereinafter, simply referred to as storage device 34). A configuration example of the processor 33 is the same as that of the processor 16. In addition, a configuration example of the storage device 34 is the same as that of the storage device 17. The processor 33 executes a computer program. The computer program is stored in the storage device 34. The computer program may be recorded on a computer-readable recording medium. The functions of the control device 32 are realized by the processor 33 that executes the computer program and the storage device 34 in cooperation with each other.

The relay server 301 includes the same adjustment content transmitter 321 as the adjustment content transmitter 241 (see FIG. 3). The relay server 301 includes an image relay unit 322 that relays transmission of the synthesized image Vc from the image transmitter 143 of the vehicle 101 to the image receiver 242 of the remote cockpit 203.

Further, the relay server 301 includes the user DB 324 and the vehicle DB 325, together with an image adjustment content DB 323 similar to the image adjustment content DB 243 (see FIG. 3). The DBs 323, 324, 325 are stored in the storage device 34. The user DB 324 stores the user ID of each user U of the remote support system 3. The vehicle DB 325 stores the vehicle ID of each vehicle 101 included in the remote support system 3. The relay server 301 (processor 33) acquires the user ID and the vehicle ID according to the operation of the login HMI 28 and the vehicle selection HMI 27 by the user U from the user DB 324 and the vehicle DB 325, respectively. The relay server 301 acquires the image adjustment content corresponding to the acquired user ID and the vehicle ID from the image adjustment content DB 323.

As described above, in the remote support system 3 according to the second modification, the image adjustment content DB 323 is provided in the relay server 301, not in the remote cockpit 203. That is, the image adjustment content DB 323 is provided to be easily accessible from the remote cockpits 203. As a result, even in a case where the user U uses the remote cockpit 203 different from the remote cockpit 203 used in the previous remote support when the user U newly performs the remote support, the user U can smoothly use the image adjustment result. The image adjustment result is image adjustment content used last time. Therefore, the remote support system 3 that is more convenient for the user U can be provided.

### Third Modification

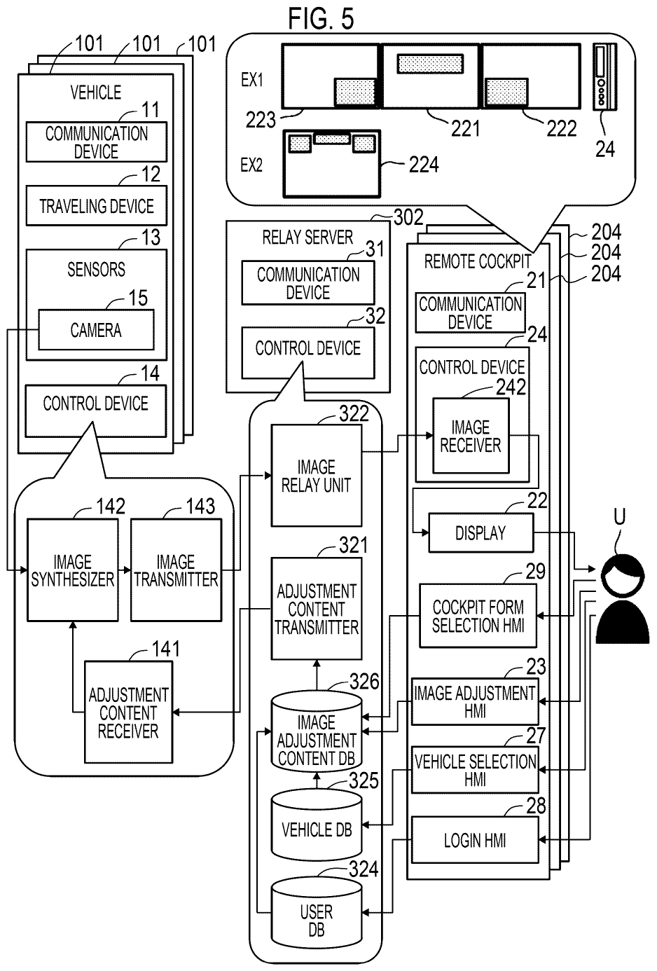

FIG. 5 is a schematic diagram showing a configuration example of the remote support system 4 according to a third modification of Embodiment 1. The remote support system 4 is different from the remote support system 3 shown in FIG. 4 in the configuration of the “remote support device” and the “relay server”.

The form of the remote cockpit used in the remote support system is not limited to one. A mode example EX1 shown in FIG. 5 shows a desktop personal computer (PC)-based remote cockpit 204. A mode Example EX2 shows a remote cockpit 204 based on a tablet PC 224 including a display and a control device 24.

In comparison with the remote cockpit 203 (see FIG. 4), the remote cockpit 204 further includes a cockpit form selection HMI 29. In the third modification, when the user U starts using the remote cockpit 204, the user U also operates the cockpit form selection HMI 29 to select the form of the remote cockpit 204. The selection of the form of the remote cockpit 204 is to input a cockpit form ID indicating the form of the remote cockpit 204 used by the user.

In comparison with the relay server 301 (see FIG. 4), the relay server 301 shown in FIG. 5 includes the image adjustment content DB 326 instead of the image adjustment content DB 323. The image adjustment content DB 326 stores the image adjustment content for each cockpit form ID in addition to each user ID and each vehicle ID. Then, the relay server 302 (processor 33) acquires the image adjustment content corresponding to the acquired user ID, the vehicle ID, and the cockpit form ID from the image adjustment content DB 326. The remote cockpit 204 may transmit the cockpit form ID of the remote cockpit 204 to the relay server 302 regardless of the input from the user U.

As described above, in the remote support system 4 according to the third modification, the image adjustment content DB 326 store the image adjustment content for each cockpit form ID (that is, for each form of the remote support terminal). As described above, by adding the remote cockpit form to the search condition of the image adjustment content DB 326, it is possible to set or reproduce the display of the synthesized image Vc for each remote cockpit form. When the remote cockpit form is different, for example, the display size or the aspect ratio may be different. Therefore, by changing the display manner of the synthesized image Vc according to the remote cockpit form, it is possible to provide the more convenient remote support system 4 for the user U. The remote cockpit form may be added to the search condition of the image adjustment content DB 326 used in Embodiment 2 described below.

### Embodiment 2

In Embodiment 1, the vehicle 101 includes an image synthesis function. On the other hand, in Embodiment 2, the remote support device includes an image synthesis function.

### Configuration of Remote Support System

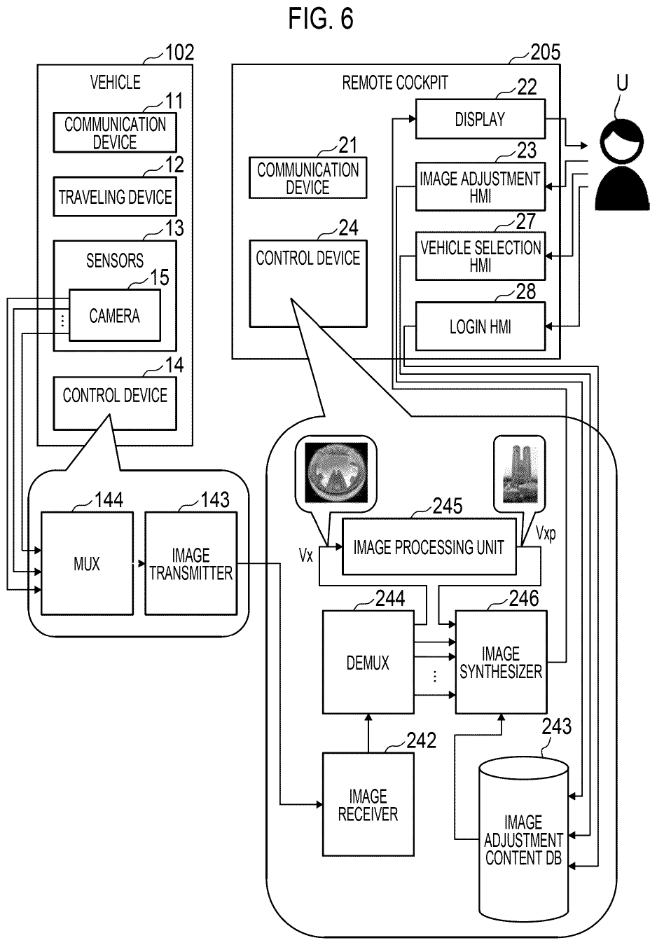

FIG. 6 is a schematic view showing a configuration example of the remote support system 5 according to Embodiment 2. The remote support system 5 includes the vehicle 102 and the remote cockpit 205 (remote support device). The control device 14 of the vehicle 102 includes a multiplexer (MUX) 144 together with an image transmitter 143 (see FIG. 1). On the other hand, the control device 24 of the remote cockpit 205 includes a demultiplexer (DEMUX) 244, an image processing unit 245, and an image synthesizer 246, together with an image receiver 242 and image adjustment content DB 243 (see FIG. 3).

In FIG. 6, the MUX 144 integrates the signals of the images V from the cameras 15 of the vehicle 102 into a single image signal, and outputs the integrated single image signal to the image transmitter 143. Examples of the images V include the images V1, V2, V3, V5, V6, and an image Vx. The cameras 15 may include, for example, an omnidirectional camera that images the surroundings of the vehicle 102. The image Vx is an image of the omnidirectional camera.

The image receiver 242 of the remote cockpit 205 outputs the single image signal received from the image transmitter 143 to the DEMUX 244. The DEMUX 244 decomposes the input single image signal into signals of the images V for each of the cameras 15. The DEMUX 244 outputs, to the image processing unit 245, the image Vx that is one of the images V, and directly outputs the remaining images V1, V2, V3, V5, V6 to the image synthesizer 246.

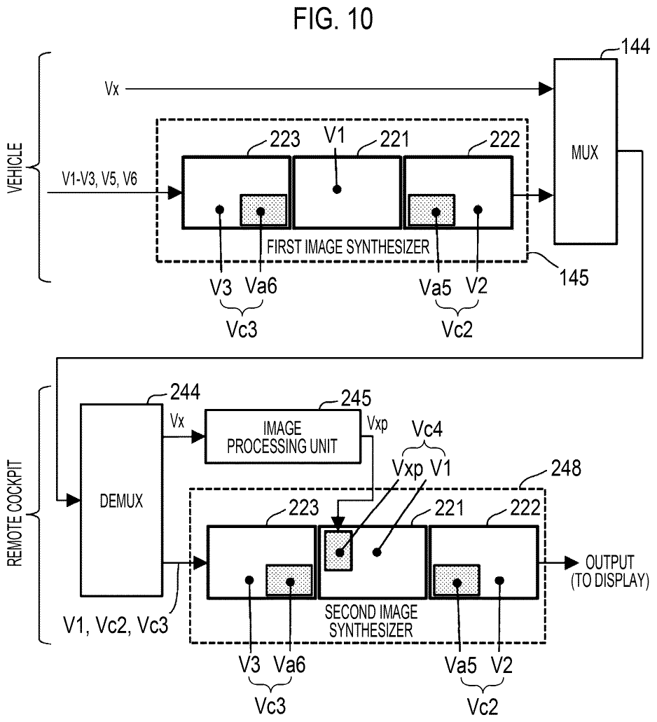

The image processing unit 245 performs an “image processing P with a high processing cost” on the input image Vx. As the image processing P, for example, processing of acquiring an image Vxp obtained by planar unfolding of the image Vx of the omnidirectional camera as shown in FIG. 6 is applied. The image processing unit 245 outputs the acquired image Vxp to the image synthesizer 246. Similar to the image synthesizer 142 (see FIG. 1), the image synthesizer 246 produces the synthesized image Vc in accordance with the image adjustment content from the image adjustment content DB 243, and outputs the produced synthesized image Vc to the display 22. An example of the synthesized image Vc produced by the image synthesizer 246 is the same as synthesized images Vc2, Vc3, Vc4 represented together with a second image synthesizer 248 in FIG. 10 described below.

With the remote support system 5 according to Embodiment 2, the customization function can be provided to the user U who performs the remote support of the vehicle 102. The customization function is a function of adjusting the image synthesis rule R regarding the synthesized image Vc displayed on the display 22 of the remote cockpit 205. As a result, the same effect as that of Embodiment 1 can be obtained.

In addition, the remote cockpit 205 included in the remote support system 5 may be, for example, a desktop PC-based terminal device equipped with a high-performance GPU suitable for executing the image processing P as the processor 25. As a result, it is possible to construct the remote support system 5 having excellent image processing performance while an increase in the image processing cost on the vehicle 102 side is reduced.

### First Modification

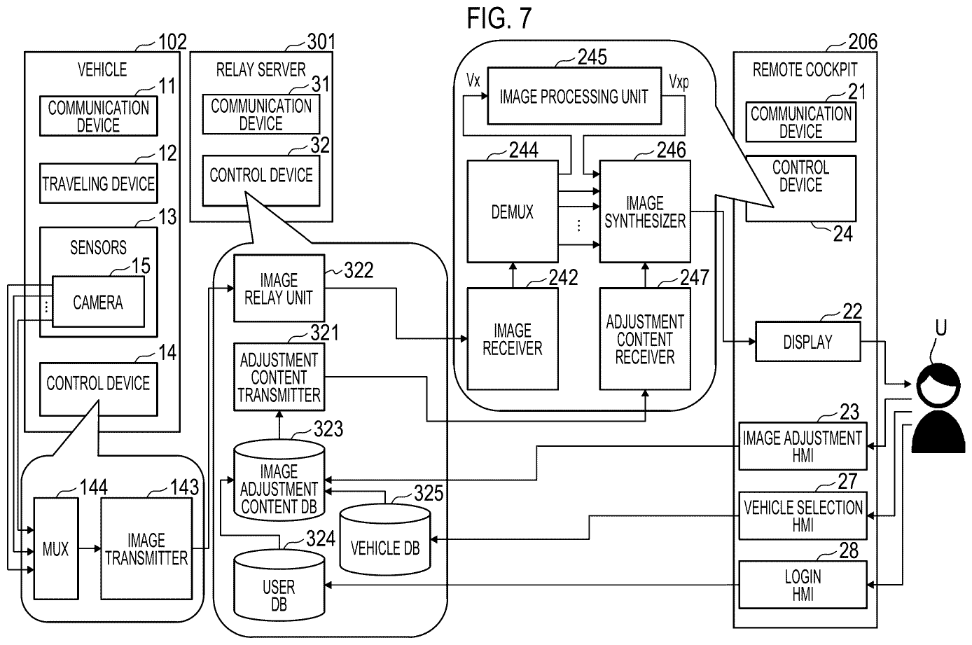

FIG. 7 is a schematic view showing a configuration example of the remote support system 6 according to a first modification of Embodiment 2. The remote support system 6 includes a remote cockpit 206 (remote support terminal) and a relay server 301 as a remote support device together with the vehicle 102. The difference between the remote support system 6 and the remote support system 5 (see FIG. 6) is the same as the difference between the remote support system 3 (see FIG. 4) and the remote support system 2 (see FIG. 3) in Embodiment 1. That is, in Embodiment 2, the image adjustment content DB 323 may be provided in the relay server 301 instead of the remote cockpit. As a result, the same effect as that of the second modification of Embodiment 1 can be obtained. In the remote support system 6, the remote cockpit 206 includes the adjustment content receiver 247.

### Second Modification

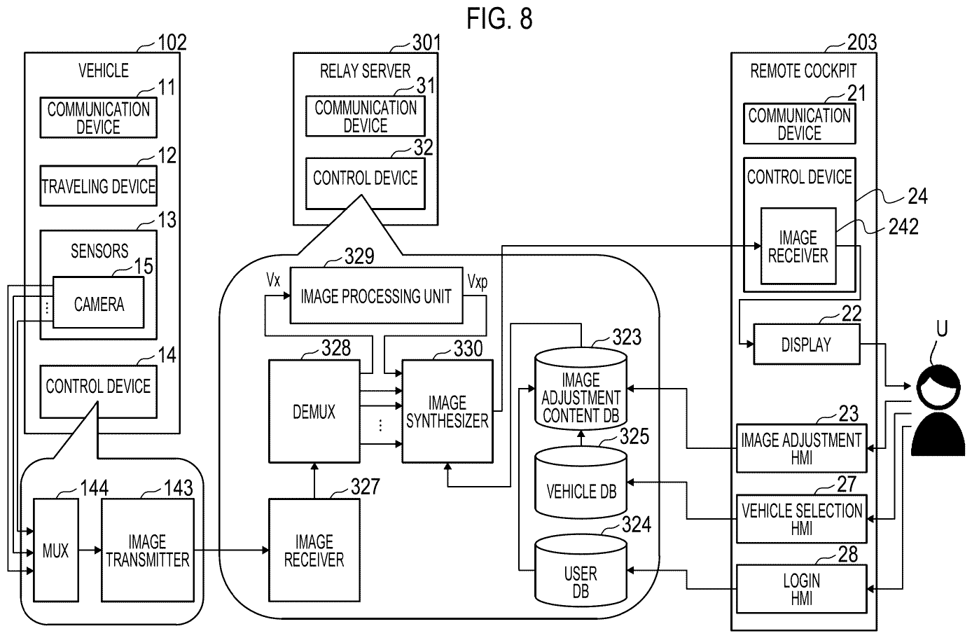

FIG. 8 is a schematic view showing a configuration example of the remote support system 7 according to a second modification of Embodiment 2. The remote support system 7 includes a remote cockpit 203 (see FIG. 4) and a relay server 303 as a remote support device together with the vehicle 102. The remote support system 7 is different from the remote support system 6 (see FIG. 7) in that the remote support system 7 has an image synthesis function in the relay server 303, not in the remote cockpit. Specifically, in comparison with the relay server 301 (see FIG. 7), the relay server 303 includes the image receiver 327 that receives the single image signal from the vehicle 102. The relay server 303 includes the same DEMUX 328, the image processing unit 329, and the image synthesizer 330 as the DEMUX 244, the image processing unit 245, and the image synthesizer 246 (see FIG. 6). In addition, as described above, the relay server 303 in the example shown in FIG. 8 also has an image processing function in addition to the image synthesis function.

According to the second modification, the remote support system 7 can be configured while the image processing capability request of the remote cockpit 203 is reduced. Therefore, the relay server 303 (for example, the GPU cloud) having high image processing capability is combined with the remote support terminal. As a result, even in a case where the tablet PC or the smartphone is used as the remote support terminal, the remote support system 7 including the image synthesis function accompanied by the image processing P with a high processing cost can be well realized.

In FIGS. 6 and 7, the control device 24 of the remote cockpit 205 or 206 (remote support terminal) including the image synthesizer 246 corresponds to the “image synthesizing device”. In FIG. 8, the control device 32 of the relay server 303 including the image synthesizer 330 corresponds to an “image synthesizing device”. Alternatively, the image synthesizer may be distributed to the remote support terminal and the relay server.

### Embodiment 3

In Embodiment 3, both the vehicle and the remote support device have the distributed image synthesis functions (first and second image synthesis functions).

### Configuration of Remote Support System

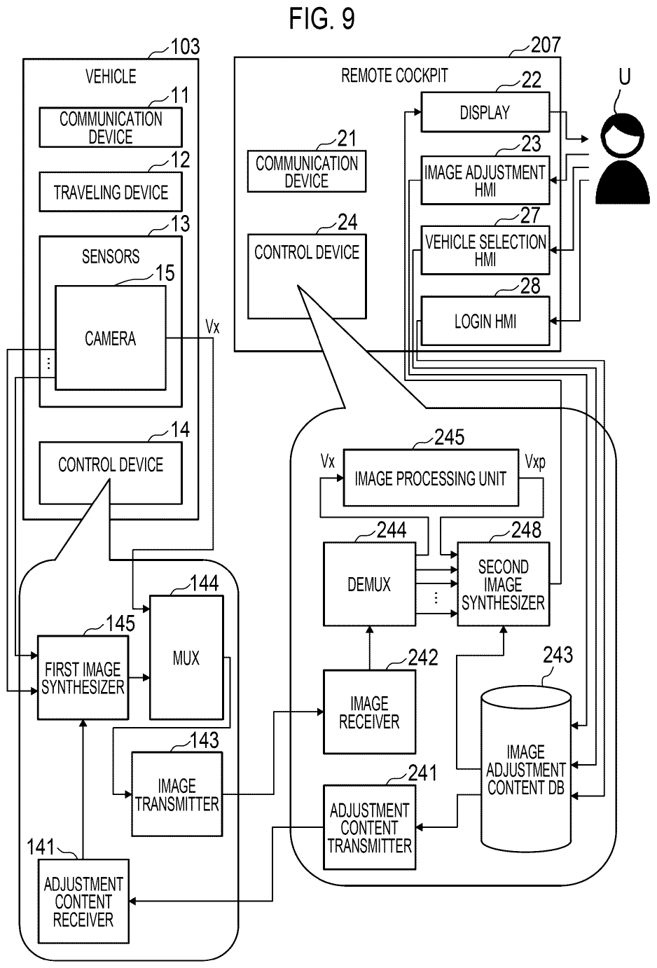

FIG. 9 is a schematic view showing a configuration example of the remote support system 8 according to Embodiment 3. The remote support system 8 includes the vehicle 103 and a remote cockpit 207 (remote support device). In comparison with the vehicle 102 (see FIG. 6), the vehicle 103 additionally includes the adjustment content receiver 141 (see FIG. 3) and the first image synthesizer 145. On the other hand, in comparison with the remote cockpit 205 (see FIG. 6), the remote cockpit 207 includes the adjustment content transmitter 241 (see FIG. 3) in addition, and includes the second image synthesizer 248 instead of the image synthesizer 246.

In FIG. 9, the control device 14 of the vehicle 103 including the first image synthesizer 145 corresponds to the “first image synthesizing device”, and the control device 24 of the remote cockpit 207 including the second image synthesizer 248 corresponds to the “second image synthesizing device”. Note that the remote support device according to Embodiment 3 may include the same relay server as the relay server 303 (see FIG. 8). The control device of the relay server may include a function block corresponding to the image processing unit 245 and the second image synthesizer 248.

### First and Second Image Synthesis Functions

FIG. 10 is a conceptual diagram showing an example of image synthesis by the first image synthesizer 145 and the second image synthesizer 248 shown in FIG. 9.

For example, images V1, V2, V3, V5, and V6 (see FIG. 2) are input to the first image synthesizer 145 of the vehicle 103. The first image synthesizer 145 produces the synthesized images Vc2, Vc3 in accordance with the image synthesis rule R (image adjustment content from the image adjustment content DB 243) (first synthesizing function) as in the image synthesizer 142 (see FIG. 2). The images V2, V3, V5, V6 serving as the images for the synthesized images Vc2, Vc3 correspond to an example of the “a plurality of first camera images” in which the image processing P with a high processing cost is not needed, among the images V of the cameras 15 of the vehicle 103. The first image synthesizer 145 outputs the produced synthesized images Vc2, Vc3 to the MUX 144 together with the image V1. In addition, the image Vx (see FIG. 6) that needs the image processing P (example: planar unfolding processing of the image of the omnidirectional camera) is also input to the MUX 144.

The DEMUX 244 of the remote cockpit 207 decomposes the single image signal from the MUX 144, outputs the image V1 and the synthesized images Vc2 and Vc3 to the second image synthesizer 248, and outputs the image Vx to the image processing unit 245. The image processing unit 245 (for example, the GPU as the processor 25) executes the image processing P to output the processed image Vxp to the second image synthesizer 248. The second image synthesizer 248 produces the synthesized image Vc4 by synthesizing the images V1, Vxp in accordance with the image synthesis rule R (image adjustment content from the image adjustment content DB 243) (second synthesizing function). The second image synthesizer 248 outputs the produced synthesized image Vc4 to the display 22 together with the synthesized images Vc2, Vc3. The images V1, Vx serving as the basis of the synthesized image Vc4 correspond to an example of “a plurality of second camera images” including the image Vx to which the image processing P is performed among the images V of the cameras 15 of the vehicle 103 in the remote support device.

As described above, with the remote support system 8 according to Embodiment 3, the synthesis of the first camera images that does not require the image processing P with a high processing cost is performed in the vehicle 103. Then, the synthesis of the second camera images including the camera image that needs the image processing P is performed in the remote support device (for example, the remote cockpit 207). As a result, the unnecessary image is removed when the first image synthesizer 145 of the vehicle 103 synthesizes the images (for example, the images V5 and V6 are cut when the adjustment images Va5 and Va6 are produced). Therefore, in comparison with the remote support system 6 (see FIG. 6), the amount of image information transmitted by the vehicle 103 is reduced, and the communication cost and the delay performance are advantageous.

What is claimed is:

1. A remote support system comprising:
a vehicle including a plurality of cameras; and
a remote support device of performing communication with the vehicle and performing remote support for the vehicle, wherein:
at least one of the vehicle and the remote support device includes an image synthesizing device configured to synthesize a plurality of camera images captured by the cameras in accordance with an image synthesis rule that is predetermined; and
the remote support device includes
a display configured to display a synthesized image synthesized by the image synthesizing device, and
an adjustment device configured to adjust the image synthesis rule in accordance with an operation of a user of the remote support device.

2. The remote support system according to claim 1, wherein the remote support device further includes one or more storage devices configured to accommodate an image adjustment content database in which image adjustment content is stored for each of the user of the remote support device, the image adjustment content being content of the image synthesis rule adjusted by the adjustment device in accordance with the operation of the user.

3. The remote support system according to claim 2, wherein:
the remote support device further includes
a remote support terminal operated by the user for the remote support, and
a relay server configured to relay the communication between the vehicle and the remote support terminal;
the remote support terminal includes the adjustment device; and
the relay server includes the one or more storage devices.

4. The remote support system according to claim 1, wherein:
the image synthesizing device includes
a first image synthesizing device included in the vehicle, and
a second image synthesizing device included in the remote support device;
the first image synthesizing device is configured to synthesize a plurality of first camera images among the camera images in accordance with the image synthesis rule, the first camera images not requiring image processing having a high processing cost; and
the second image synthesizing device is configured to synthesize a plurality of second camera images among the camera images in accordance with the image synthesis rule, the second camera images including a camera image on which the image processing is performed in the remote support device.

5. The remote support system according to claim 2, wherein:
the remote support device includes a remote support terminal operated by the user for the remote support; and
the image adjustment content database stores the image adjustment content for each form of the remote support terminal.
